(19) United States
(12) Patent Application Publication
(10) Pub. No.: US 2023/0237734 A1
(43) Pub. Date: Jul. 27, 2023

(54) 3D BIOLOGICAL CELL CONSTITUENT CONCENTRATION

(71) Applicant: Hewlett-Packard Development Company, L.P., Spring, TX (US)

(72) Inventors: Yang Lei, Palo Alto, CA (US); Viktor Shkolnikov, Palo Alto, CA (US); Daixi Xin, Palo Alto, CA (US)

(73) Assignee: Hewlett-Packard Development Company, L.P., Spring, TX (US)

(21) Appl. No.: 18/007,736

(22) PCT Filed: Jun. 5, 2020
(86) PCT No.: PCT/US2020/036217

§ 371 Date: Dec. 1, 2022

(51) Int. Cl. G06T 17/00

(52) U.S. Cl. CPC G06T 17/00; G06T 2210/41

(57) ABSTRACT

A three-dimensional (3D) biological cell constituent concentration reconstruction method may include capturing two-dimensional images of a biological cell at different angles, virtually partitioning the biological cell into a 3D stacks of voxels, assigning cell constituent concentration estimations to respective voxels based upon a plurality of the two-dimensional images and forming a 3D cell constituent concentration model of the biological cell based upon the voxels and respective cell constituent concentration estimations.

### BACKGROUND

Biological cells are sometimes imaged to identify structures within cells or other characteristics of the cells. Such biological cells are sometimes modeled or reconstructed to facilitate further study of such cells.

### BRIEF DESCRIPTION OF THE DRAWINGS

FIG. 1 is a diagram schematically illustrating portions of an example 3D biological cell constituent concentration modeling or reconstruction system.

FIG. 2 is a block diagram illustrating portions of an example non-transitory computer-readable medium of the system of FIG. 1.

FIG. 3 is a flow diagram of an example 3D biological cell constituent concentration reconstruction method.

FIG. 4 is a perspective view of a diagram illustrating example partitioning of a biological cell into voxels.

FIG. 5 is a diagram illustrating an example 2D image with different regions having different light intensity characteristics corresponding to different voxels of the biological cell.

FIG. 6 is a diagram illustrating an example partitioning of a biological cell into example voxels and impingement of light from the voxels onto a camera image plane forming a 2D image.

FIG. 7 is a diagram illustrating an example 2D image with a region having a light intensity characteristics corresponding to voxels of a biological cell.

FIG. 8 is a diagram illustrating multiple example 2D images of the rotating biological cell at different angles.

FIG. 9 is a sectional view illustrating a portion of the example 2D images and a portion of the voxels of the example biological cell of FIG. 8.

FIGS. 10A, 10B, 10C and 10D are micrographs of an example 3D model produced by an example of the system of FIG. 1.

FIG. 11 is a diagram illustrating an example transformation between a camera coordinate system and they biological cell coordinate system.

FIG. 11 is a diagram schematically illustrating portions of an example 3D biological CCC reconstruction system.

Throughout the drawings, identical reference numbers designate similar, but not necessarily identical, elements. The FIGS. are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example methods, systems and processor instructions that facilitate the forming of three-dimensional (3D) cell constituent concentration models of a biological cell from two-dimensional (2D) images of the biological cell at different angles. The example methods, systems and processor instructions virtually partition a biological cell into 3D stacks of voxels (volume elements). Cell constituent concentration estimations are assigned to different voxels of each of the stacks based upon different combinations of the two-dimensional images. Each individual concentration estimation for a particular constituent or group of constituents in a particular voxel is based upon a combination of different two-dimensional images at different angles. A larger 3D cell constituent concentration model of the biological cell may be generated based upon the voxels and their respective cell constituent concentration estimations.

In contrast to confocal imaging techniques which involve precision stepping, confocal optics and/or high sensory cameras, the example methods, systems and processor instructions may provide cell constituent concentration modeling of the biological cell without precision stepping and without confocal optics. In contrast to confocal imaging techniques, the example methods, systems and processor instructions may assign different cell constituent concentration estimations to different voxels forming the 3D stack of voxels without capturing a different image in a different focal plane for each different voxel of the stack. Instead, the example methods, systems and processor instructions determine different cell constituent concentration estimations for the different individual voxels of the stack based upon different combinations of two-dimensional images at different angles.

For example, a cell constituent concentration estimation for a first voxel of the stack may be based upon data combined from a first set of 2D images captured at different angles. A cell constituent concentration estimation for a second voxel of the stack may be based upon data combined from a second set of two-dimensional images, different than the first set of 2D images, and captured at different angles. A cell constituent concentration estimation for a third voxel of the stack may be based on data combined from a third set of 2D images, different than the first set and the second set, and captured at different angles. In some implementations, different cell constituent concentration estimations for the voxels of the stack may be determined based upon different combinations of 2D images captured using wide field microscopy. As a result, the complexity and cost of modeling the cell constituent concentrations of biological cells or particular portions of the biological cells may be reduced.

In some implementations, the 2D images comprise images of reflected or incident light from the biological cell. In some implementations, the 2D images comprise images of fluorescent light emanating from the biological cell. For example, particular molecules may be targeted with a fluorescent agent, wherein brighter regions of the 2D image may correspond to those regions (in 2D) of the biological cell containing the target molecules. The brighter the region of the 2D image, the greater the concentration of the target molecules in the region of biological cell corresponding to the region of the 2D image.

In some implementations, the 2D images comprise images of light that has passed through the biological cell and light that has been blocked by particular molecules of the biological cell. The 2D images may indicate the amount of light that has been blocked by particular target molecules/target constituents of a biological cell. For example, particular molecules may be targeted with a stain or other light blocking agent, wherein the darker regions of the 2D image may correspond to those regions (in 2D) of the biological cell containing the target molecules. The darker the region of the 2D image, the greater the concentration of the target molecules in region of the biological cell corresponding to the region of the 2D image.

In some implementations, the voxels of the stack are treated as linearly (or equally) contributing to a summed or total light intensity measurement of a region of the 2D image that corresponds to the location of the stack. In some implementations, different voxels of the stack are treated as differently contributing to the summed or total light intensity measurement of the region of the 2D image corresponding to the stack. For example, a first voxel of the stack may be treated as contributing a first portion of the total light intensity for the associated region of the 2D image, resulting in the first voxel being assigned a first concentration estimation. In contrast, a second voxel of the stack may be treated as contributing a second different portion of the total light intensity for the associated region of the 2D image, resulting in the second voxel being assigned a second concentration estimation different than the first concentration estimation. In some implementations, the apportionment of the total light intensity for a region of the 2D image to individual voxels of the stack of voxels associated with the region of the 2D image may be based upon the positioning or location of the individual voxels in the stack. In some implementations, the total light intensity measurement region of the 2D image may correspond to multiple stacks through which a conical cone of light has been transmitted. In such implementations, the total light intensity measurement may be differently allocated amongst different voxels of different stacks based upon an extent to which the cone of light contains the different individual voxels.

Disclosed is an example three-dimensional (3D) biological cell constituent concentration reconstruction method. The example method may include capturing two-dimensional images of a biological cell at different angles, virtually partitioning the biological cell into a 3D stacks of voxels, assigning cell constituent concentration estimations to respective voxels based upon a plurality of the two-dimensional images and forming a 3D cell constituent concentration model of the biological cell based upon the voxels and respective cell constituent concentration estimations.

Disclosed is an example three-dimensional (3D) biological cell constituent concentration reconstruction system. The system may comprise a cell rotator to rotate a biological cell, a camera to capture two-dimensional images of the biological cell at different angles, a processor and a non-transitory computer-readable medium. The medium may contain instructions to direct the processor to (1) virtually partition the biological cell into 3D stacks of voxel, (2) assign cell constituent concentration estimations to respective voxels, each cell constituent concentration estimation being based upon a plurality of the two-dimensional images and(3) form a 3D cell constituent concentration model of the biological cell based upon the voxels and respective cell constituent concentration estimations.

Disclosed is an example non-transitory computer-readable medium that contains instructions to direct operation of a processor. The instructions comprise partition instructions to direct the processor to virtually partition a biological cell into 3D stacks of voxels, cell constituent concentration estimation instructions to direct the processor to determine cell constituent concentration estimations for respective voxels, each cell constituent concentration estimation being based upon a plurality of two-dimensional images of the biological cell and model formation instructions to direct the processor to form a 3D cell constituent concentration model of the biological cell based upon the voxels and respective cell constituent concentration estimations.

FIG. 1 is a diagram schematically illustrating portions of an example 3D biological cell constituent concentration reconstruction system 20. System 20 generates or forms a 3D cell constituent concentration (CCC) model of a biological cell based upon a plurality of 2D images taken at different angles about the biological cell. The cell constituent concentration model may identify different densities or concentrations of particular cell constituents, such as molecules, within and forming the biological cell. System 20 comprises cell rotator 24, camera 28, processor 32 and a non-transitory computer-readable medium, in the form of a memory 36.

Cell rotator 24 comprises a structure or device for suspending and rotating a biological cell. In some implementations, cell rotator 24 may comprise a chamber 40 that is to contain a liquid 42 in which a biological cell 44 may be rotated. In some implementations, cell rotator 24 comprises electrically charged electrodes that apply an electric field with respect to gravity, holding, levitating and rotating biological cell 44 within chamber 40 during imaging. In some implementations, the electrodes are electrically charged so as to apply dielectrophoretic to suspend and rotate the biological cell 44. In some implementations, cell rotator 24 utilizes charged electrodes to establish a the nonrotating nonuniform electric field for rotating biological cell 44. In some implementations, the nonrotating nonuniform electric field is an alternating current electric field having a frequency of at least 650 kHz and no greater than 300 kHz. In one implementation, the nonrotating nonuniform electric field has a voltage of at least 0.1 V rms and no greater than 100 V rms.

Camera 28 comprises an optical sensor with associated imaging optics. In one implementation, camera 28 comprises a CMOS array or a charge coupled device (CCD) device. Camera 28 output signals representing captured 2D images of biological cell 44 to processor 32. In the example illustrated, camera 28 is illustrated as being located to a side of chamber 40, generally opposite to a transparent portion of chamber 40. In other implementations, camera 28 may be located above or below flow passage 24.

During imaging, biologic cell 44 is rotated as camera 20 captures 2D images of biological cell 44 at different angles, during different degrees of rotation about a rotational axis. As will be described hereafter, these multiple 2D images of biologic cell 44 at the different angles are used by processor 32 and memory 36 to determine different cell constituent concentrations throughout or within the biological cell 44. In some implementations, instead of the 2D images being captured by a generally stationary camera 28 while biological cell 44 is rotated, the 2D images at different angles may be captured using a series of cameras 28 extending about a generally stationary suspended biological cell 44.

Processor 32 carries out instructions contained in memory 36. Processor 32 may comprise an integrated circuit or hardware.

Memory 36 comprises a non-transitory computer-readable medium that provides instructions for the operation of processor 32. Memory 36 may comprise an integrated circuit or programming such as software or code for directing the operation processor 32. Instructions contained in memory 36 direct processor 32 to virtually partition the biological cell 44 into 3D stacks of voxels and to determine CCC estimations for the respective voxels of each of the stacks based upon a plurality of two-dimensional images output by camera 28. As will be described below, each CCC estimation for each voxel of each stack is based upon a combination of a plurality of different 2D images of the biological cell 44. In some implementations, the instruction contained in memory 36 may direct processor 32 to generate a 3D CCC model of the biological cell 44. In some implementations, the instruction contained in memory 36 may additionally direct processor 32 to output control signals controlling the operation of camera 28 and/or the operation of cell rotator 24.

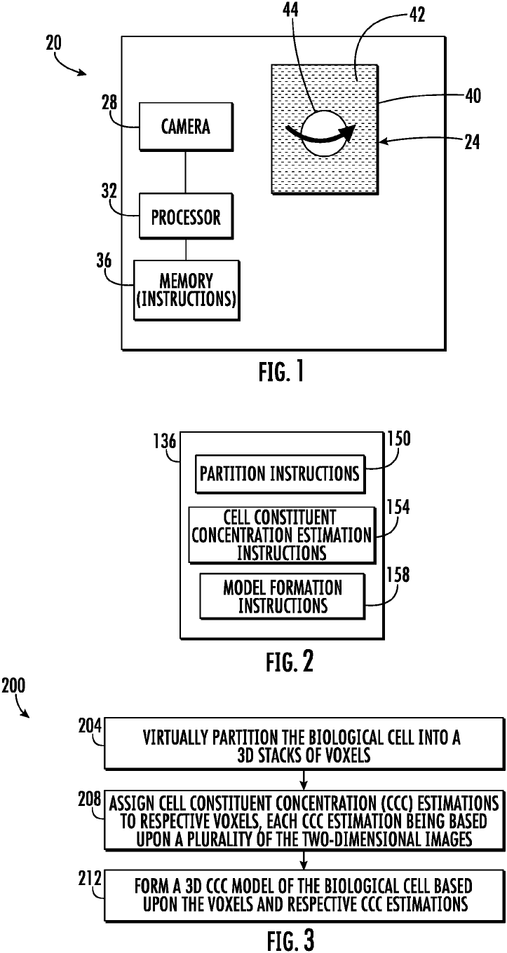

FIG. 2 is a block diagram schematically illustrating memory 136, one example of memory 36 of system 20. Memory 136 comprises a non-transitory computer-readable medium that contains instructions for directing processor 32 to carry out an example 3D biological cell constituent concentration reconstruction method 200 shown in FIG. 3. In the example illustrated, memory 136 comprises partition instructions 150, cell constituent concentration estimation instructions 154 and model formation instructions 158.

Partition instructions 150 direct processor 32 to carry out block 204 of method 200 in FIG. 3. Partition instructions 150 direct processor 32 to virtually partition biological cell 44 into three 3D stacks of voxels. Each stack of voxels comprises a series of consecutive voxels which are stacked relative to one another in a direction away from camera 28 such that voxels of the stack are located behind the frontmost voxel closest to the camera 28.

In some implementations, partition instructions 150 direct processor 32 to first determine an outer surface or contour of the example biological cell 44. In some implementations, processor 32 may use prior stored models for the particular type of biological cell 44 being analyzed and/or modeled to determine or estimate the contour of biological cell 44 being analyzed. In some implementations, processor 32 may direct camera 28 to capture 2D images of the biological cell 44, were in process 32 uses the 2D images to determine the 3D outer contour of biological cell 44. Based upon the determined or estimated outer contour of biological cell 44, processor 32 may partition biological cell 44 into a 3D grid or matrix of voxels (also known as volume elements). In some implementations, processor 32 (following partition instructions 150) may partition the biological cell 44 using preset or predetermined voxel sizes and shapes. For example, the predetermined voxel size and/or shape may be set by a user or established based upon the characteristics of system 20, such as the resolution of camera 28, and the magnification of additional optical system, such as microscopes. In some implementations, processor 32 may determine or choose a voxel size and/or voxel shape based upon the size and/or shape of the particular biological cell 44 being analyzed, wherein the partitioning of the particular biological cell by processor 32 is based upon the chosen voxel size and/or shape.

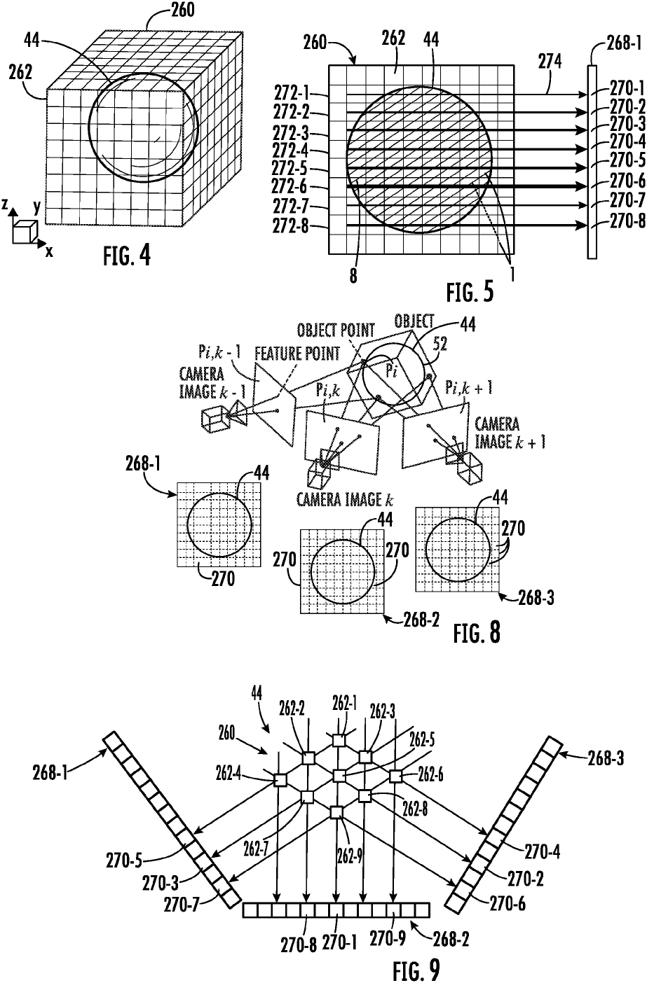

FIG. 4 illustrates the example biological cell 44 virtually partitioned into an example 3D matrix 260. The 3D matrix 260 is formed from a 3D array of individual voxels 262. The voxels 262 are arranged in corresponding columns, rows or stacks. Each individual voxel 262 may be concurrently located within multiple stacks centered about extending from each individual voxel 262 depending upon the direction along which the stack extends.

Although the example matrix 260 is illustrated as comprising a 3D array of uniformly sized voxel 262, in some implementations, matrix 260 may be formed from an array of non-uniformly sized voxels 262, where different voxels may have different shapes or be differently sized. Although the example matrix 260 is illustrated as having linear stacks of voxels extending in each of the x, y and z directions of an orthogonal coordinate system, in some implementations, matrix 260 may be formed from stacks of voxels having other layout such as stacks radially outwardly extending from a center point. Although the individual voxels 262 are illustrated as being cubes, and some implementations, the individual voxels 262 may be other three-dimensional solids, such as a polyhedron or the like. As should be appreciated, the size of each of voxels 262 and the number of voxels 262 forming matrix 260 may vary depending upon the size and shape of biological cell 44, the resolution of camera 28, the magnification of additional optical system, such as microscopes, and an amount of processing bandwidth or available time for making CCC determinations.

In some implementations, matrix 260 encapsulates or surrounds the biological cell 44 being partitioned. As a result, those individual voxels 262 that contain the outermost surface of biological cell 44 may be partially empty or partially outside of biological cell 44. In some implementations, those voxels 262 wholly outside of biologic cell 44 are left as part of matrix 260, wherein the CCC estimations for such empty voxels will be zero. In some implementations, those voxels 262 wholly outside of biologic cell 44 are removed from matrix 260 such a matrix 260 and a shape generally corresponding to the shape of biological cell 44. Removing empty voxels 262 may, in some implementations, reduce the computational burden upon processor 32.

In some implementations, the sizes of the individual voxels 262 may be iteratively reduced by processor 32 to reduce or eliminate the extent to which those voxels 262 containing the outer contour of biological cell 44 are empty. For example, processor 32 may iteratively subdivide larger initial voxels 262 into smaller sized subdivided voxels, wherein those subdivided voxels outside of the surface or contour of the biologic cell 44 are either removed or tagged by processor 32 as not containing the biological cell 44. The instructions 36 contained in memory 36, 136 may direct processor 32 to skip any processing or CCC determinations for such tagged subdivided voxels. In some implementations, processor 32 may iteratively carry out the subdivision of voxels into smaller voxels until the outermost voxels containing the contour of biological cell 44 sufficiently match the outer surface or contour of the biological cell 44 by a predetermined threshold or extent.

Cell constituent concentration estimation instructions 154 (shown as part of memory 136 in FIG. 2) direct processor 32 to carry out block 208 of method 200 of FIG. 3. Instructions 154 direct processor 32 to determine and assign CCC estimations to respective voxels, wherein each CCC estimation for each individual voxel is based upon a plurality of two-dimensional (2D) images captured by camera 28. In some implementations, instructions 154 direct processor 32 to output control signals that cause cell rotator 24 to rotate biological cell 44 at a predetermined and controlled rotational rate and that further cause camera 28 to capture 2D images of the biological cell 44 at different angles. In some implementations, processor 32 directs camera 32 to continuously capture 2D images during the rotation of biological cell 44, the 2D images forming a continuous scan of biological cell 44 at a continuum of angular positions about biological cell 44. In some implementations, processor 32 directs camera 32 to capture 2D images at predetermined angularly spaced positions about biological cell 44.

The 2D images captured by camera 28 may have varying degrees of light intensity or levels of brightness across the face of the 2D images, in two dimensions. FIG. 5 illustrates a single 2D image 268 at one particular angle of the example biological cell 44. 2D image 268 has different regions 270-1, 270-2, 270-3, 270-4, 270-5, 270-6, 270-7 and 270-8 (collectively referred to as regions 270) which have light intensity values that are associated with respective stacks 272-1, 272-2, 272-3, 272-4, 272-5, 272-6, 272-7, 272-8 (collectively referred to as stacks 272) of matrix 260. As indicated by arrows 274, the light intensity value of each of regions 270 may be the result of a sum of the light intensity contributions of each of the individual voxels 262 in the respective stacks 272. For example, the light intensity value of region 270-2 is a result of the sum of those contributions of each of the individual voxels forming stack 272-2. In the diagram shown in FIG. 5, the different thicknesses of arrows 274 represent different light intensities captured by the associated regions 270.

In some implementations, the different regions 270 of 2D image 268 have varying light intensity values based upon reflected or incident light from the biological cell 44. Different constituents of biological cell 44 may reflect and/or absorb light differently. As a result, the different light intensity values amongst regions 270 may indicate different concentrations for a particular constituent of biological cell 44 in the different stacks 272.

In some implementations, light or fluorescent emitting tags or markers are attached to targeted constituents of biological cell 44. Such markers have a chemical composition that results in the markers having a higher propensity to attach or bind to certain targeted types of constituents or molecules as compared to other non-targeted types of constituents or molecules. For example, a fluorophore, a fluorescent chemical compound that can reemit light upon light excitation, may be directly or indirectly attached to certain constituents (molecules) of biological cell 44 so as to function as a tag or marker. In such implementations, the different light intensity values amongst regions 270 may indicate different concentrations of the marker, and therefore different concentrations of the particular constituent to which the marker binds, in the different stacks 272. The brighter regions 270 of the 2D image may correspond to those regions (in 2D) of the biological cell 44 containing the target molecules. The brighter the region 270 of the 2D image, the greater the concentration of the target molecules in the respective stack.

In some implementations, a light source transmits light (visibly perceptible or visibly non-perceptible electromagnetic radiation) through the translucent or transparent portions of biological cell 44 towards camera 28. Such backlighting of biological cell 44 may result in particular constituents of biological cell 44 forming a shadow in the 2D image 268. The shadow may be result of particular constituents tending to absorb or reflect light to a greater extent as compared to other constituents. The different light intensities across 2D image 268 caused by the differing shadows across 2D image 268 may correspond to an indicate different concentrations of the constituents in the different stacks 272.

In some implementations, a stain or light blocking agent may be applied to biological cell 44, wherein the stain or light blocking agent has a propensity to attach to or be absorbed by particular target constituents or molecules to a greater extent as compared to other non-targeted constituents or molecules. The stain or light blocking agent may increase the ability of the targeted molecule or constituent to block light (either through reflection or absorption) so as to prevent the light from passing through or past the targeted molecule to camera 28. As a result, the darker or shadow regions of the 2D image 268 may correspond to those stacks 272 having a greater concentration of the target constituents or molecules. The darker the region 270 of the 2D image, the greater the concentration of the target molecules in the respective stack 272. Examples of such a stain or light blocking agent include, but are not limited to, immunochemistry with fluorescent antibodies, reporter proteins in transgenic cells, and histochemical stains including eosin, hematoxylin, and other reagents.

Instructions 154 direct processor 32 to measure or otherwise determine different light intensity values for regions 270 of 2D image 268. Instructions 154 further direct processor 32 to determine which full or partial stacks 272 of voxels 262 contributed to the light intensity value for each of regions 270 of 2D image 268. Upon determining what full or partial stacks 272 contributed to the light intensity value of particular region 270, processor 32 allocates the light intensity value of the particular region 270 amongst the different voxels of the stack 272 or group of stacks 272. In some implementations, processor 32 equally apportions the light intensity value of a particular region 270 amongst each of the voxels 262 of the particular stack 272 corresponding to the particular region (and through which light passed prior to impinging the particular region) amongst the individual voxels 262 of the particular stack 272. For example, the light intensity value measured at region 270-5 may be equally apportioned amongst each of the individual voxels of stack 272-5.

In some implementations, processor 32 may differently allocate the light intensity value of a particular region amongst the voxels 262 of the particular stack 272 or group of stacks 272, corresponding to the particular region, amongst the individual voxels 262 of the particular stack or group of stacks based upon the relative positions of the individual voxels along the stack or stacks. For example, processor 32 may allocate a greater percentage of the light intensity value of region 270-5 to those voxels 262 of stack 272-5 that are closest to the imaging plane forming the 2D image 268. Voxel 1 of stack 272-5 may be allocated a greater percentage of the light intensity value of region 270-5 as compared to the individual voxel 8 of stack 272-5.

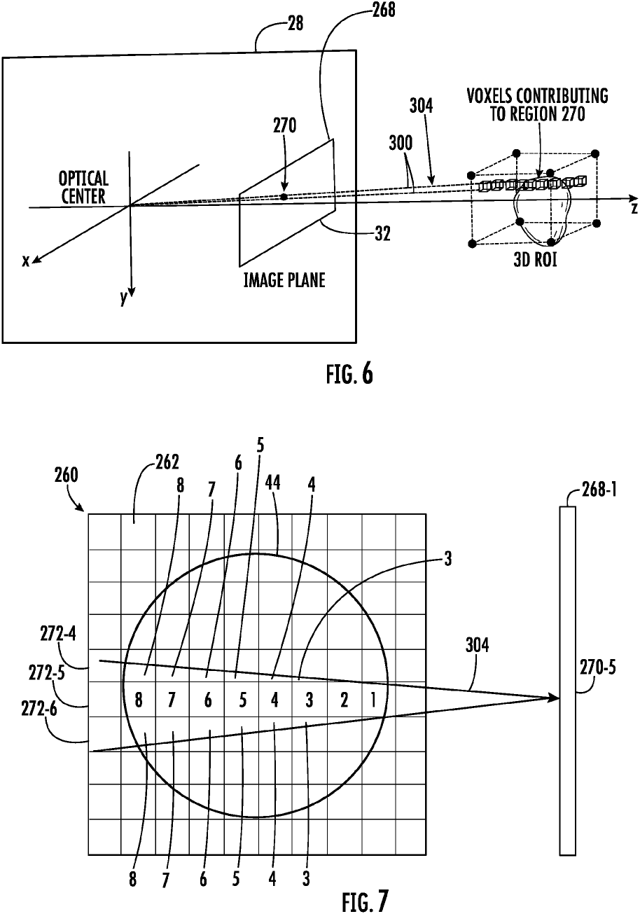

As shown by FIGS. 6 and 7, in some implementations, the light rays 300 impinging an image plane 302 of camera 28 and resulting in a light intensity value for particular region 270 of the 2D image 268 may be divergent, in the shape of a three-dimensional cone 304. As a result, as shown by FIG. 8, some voxels may be fully contained within the cone 304 of light while other voxels are only partially within the cone 304 of light. The cone 304 of light may fully contain some voxels and partially intersect or contain other voxels. Said another way, narrower portions of the cone 304 of light, closest to the imaging plane or camera 28 may be completely contained within a single central stack 270 of voxels 262 while wider portions of the cone 304 of light, farther away from the imaging plane or camera 28, may extend within the central stack 270 of voxels 262 and may widen further outward so as to intersect the voxels 262 of other stacks 270 that surround the central stack 270.

In such implementations, processor 32 may differently allocate the light intensity value of the particular region 270 of the 2D image 268 amongst different voxels 262 of different stacks 270 based upon a determined extent to which the voxels 262 are contained within the conical shaped set of light rays. Processor 32 may allocate a greater percentage of the light intensity value to those voxels 262 of the central stack which are more fully aligned or more fully contained by the cone 304 of light. Processor 32 may allocate a smaller percentage of the light intensity value to those voxels 262 of the surrounding stacks 270 through which the cone 304 of light partially intersects, passing through a side portion of the voxel, but not passing through other side portions of the same voxel. For example, processor 32 may allocate a greater percentage of the light intensity value measured at region 270-5 of 2D image 268 to voxels 1-8 of stack 272-5 (determined to be within the outer contours of cell 44) as compared to voxels 3-8 of stacks 272-4 and 272-6, the surrounding stacks. Likewise, processor 32 may allocate larger percentages of the light intensity value measured at region 270-5 to voxels 8 of stacks 272-4 and 272-6 as compared to voxels 7 of stacks 272-4 and 272-6. Processor 32 may allocate larger percentages of the light intensity value measured at region 270-52 voxel 7 of stacks 272-4272-6 as compared to voxels 6 of stacks 2754 and 275-6, and so on.

Upon allocating the light intensity value of each region 270 of 2D image 268-1 to individual voxels 262, processor 32 carries out the same process with respect to additional 2D images 268 taken at different angles. FIG. 8 illustrates 2D images 268-2 and 268-3 of biological cell 44 taken at different angles about biological cell 44. FIG. 8 illustrates the example two-dimensional images 268-1, 268-2, 268-3 (collectively referred to have 2D images 268) of biological cell 44, taken at different angular positions about biological cell 44. In the example illustrated, each of 2D images 268 comprise a 2D array of regions 270 which have dimensions corresponding to the dimensions of the individual voxels 262. In other implementations, the regions 270 may have individual dimensions that are different from the dimensions of the individual voxels 262. For example, in implementations where individual regions 270 are smaller than an individual voxel 262, multiple regions 270 may have a light intensity characteristic or value that is attributable to a single stack 272 of voxels 262. In implementations where individual regions 270 are larger than individual voxels, a single region 270 may have a light intensity characteristic or value that is attributable to multiple stacks 272 of voxels 262. As shown by FIG. 5, each of the regions 270 may have a different light intensity characteristic which may be the result of different CCCs throughout the biological cell 44.

As with 2D image 268-1, for each region 270 of 2D image 268-2, processor 32 identifies what stack 272 or group of stacks 272 contributed to the light intensity value for the particular region 270 of 2D image 268-2. Processor 32 then allocates the light intensity value of the particular region 270 amongst the individual voxels 262 of the identified stack 272 or group of stacks 272. Likewise, for each region 270 of 2D image 216-3, processor 32 identifies what stack 272 or group of stacks 272 contributed to the light intensity value for the particular region 270 of 2D image 268-3. Processor 32 then allocates the light intensity value of the particular region 270 amongst the individual voxels 262 of the identified stack 272 or group of stacks 272.

As a result, each individual voxel 262 may have multiple different assigned 2D light intensity values. A 2D light intensity value is a light intensity value based upon a single 2D image. An individual voxel 262 may have a first 2D light intensity value based upon a particular region of 2D image 268-1, a second different 2D light intensity value based upon a particular region of 2D image 268-2 and a third different 2D light intensity value based upon a particular region of 2D image 268-3. As described below, processor 32 uses these three different 2D light intensity values derived from the three different 2D images to estimate a final 3D light intensity value for the individual voxel which is then used to estimate a CCC value for the individual voxel. A 3D light intensity value is a light intensity value derived from multiple 2D light intensity values.

To determine and assign different CCC estimates to different individual voxels, instructions 154 direct processor 32 to identify the particular region 270 or set of regions 270 of each of multiple 2D images 268, taken at different angles, that corresponds to an individual voxel 262. In some implementations, instruction 154 direct processor 32 to carry out such identification for each individual voxel 262, identifying corresponding regions of the different 2D views that correspond to each individual voxel 262. In some implementations, to reduce the consumption of processing bandwidth, such identification may be carried out for a portion or selected regions or voxels of biological cell 44.

FIG. 9 illustrates an example of how different regions of different 2D images may be associated with the same individual voxel 262 of biological cell 44. FIG. 9 is a sectional view illustrating a portion of each of 2D images 268 and a portion of a three-dimensional matrix 260 of individual voxels containing the biological cell 44. As shown by FIG. 9, each individual voxel 262 may contribute to the light intensity characteristic of a particular region 270 of each of the different 2D images 268. FIG. 9 schematically illustrates individual voxels 262-1, 262-2, 262-3, 262-4, 262-5, 262-6, 262-7, 262-8, and 262-9. It should be understood that the example voxels 262 shown in FIG. 9 may be adjacent to one another in matrix 260 or may be separated by intervening voxels that are not shown in FIG. 9 for ease of illustration.

As shown by FIG. 9, each voxel 262 may be a member of multiple stacks extending in different directions. For example, voxel 262-5 is part of a first stack of voxels, along with voxel 262-1 and 262-9, that contributes to a light intensity value for region 270-1 of 2D image 268-2. The same voxel 262-5 is also part of a second stack of voxels, along with voxel 262-2 and voxel 262-8, that contributes to a light intensity value for region 270-2 of 2D image 268-3. The same voxel 262-5 is also part of a third stack of voxels, along with voxels 262-3 and 262-7 that contributes to a light intensity value for region 270-3 of 2D image 268-1. As described above, instructions 154 direct processor 32 to identify those regions of each of the different 2D images 268 that have light intensity values partially attributable to the same voxel. In the example illustrated, process 32 would determine that regions 270-1, 270-2 and 270-3 of 2D images 268-2, 268-3 and 268-1, respectively, have light intensity values partially attributable to the same voxel, voxel 262-5. The same determination may be made by processor 32 for each of the voxels 262 of matrix 260.

Upon determining which particular regions 270 of the different 2D images 268 correspond to a particular individual voxel 262, processor 32, following instructions contained in memory 154, determines and assigns a 3D CCC estimate to the particular voxel based upon a combination of the measured 2D light intensity values from those particular regions 270 that correspond to the particular individual voxel 262. A 3D CCC estimate or value is a CCC value that is derived from a combination of values from multiple 2D images. Processor 32 determines and assigns a 3D CCC estimate to a particular individual voxel based upon a combination of the light intensity values allocated to the particular voxel from each of the different 2D images. For example, instruction 154 direct processor 32 to determine and assign a 3D CCC estimate to voxel 262-5 using a combination of those portions of the 2D light intensity values from regions 270-1, 270-2 and 270-3 allocated or apportioned to voxel 262-5. Likewise, following instructions 154, processor 32 may determine and assign a 3D CCC estimate to voxel 262-1 using a combination of those portions of the 2D light intensity values from regions 270-1, 270-4 and 270-5 allocated or apportioned to voxel 262-1. Processor 32 may determine and assign a 3D CCC estimate to voxel 262-9 using a combination of those portions of the 2D light intensity values from regions 270-1, 270-6 and 270-7 allocated or apportioned to voxel 262-9. Processor 32 may determine and assign a 3D CCC estimate to voxel 262-2 using a combination of those portions of the 2D light intensity values from regions 270-8, 270-2 and 270-5 allocated or apportioned to voxel 262-2. Processor 32 may determine and assign a 3D CCC estimate to voxel 262-6 using a combination of those portions of the 2D light intensity values from regions 270-9, 270-4 and 270-7 allocated or apportioned to voxel 262-6. Similar determinations and 3D CCC estimate assignments may be made for each of the voxels 262 of matrix 260 using a combination of those portions of the 2D light intensity values from those regions of the different 2D images that have been allocated or apportioned to each individual voxel.

In the above example, a final 3D light intensity value is determined for each individual voxel based upon the set of individual 2D light intensity allocations from the different 2D images at different angles, wherein the 3D light intensity value for the individual voxel is then correlated to a corresponding CCC estimate value for the individual voxel. In such implementations, instructions 154 may direct processor 32 to consult a lookup table which associates different 3D light intensity values for the different regions 270 with different 3D CCC estimations. In some implementations, instructions 154 may direct processor 32 to estimate a 3D CCC estimate for an individual voxel using an empirically determined formula, wherein the 3D light intensity value serves as an input to the formula. The lookup table or formula may be stored in memory 36 or may be stored in a remote database that is accessible by processor 32. The particular values for the lookup table or the particular characteristics of the formula may vary depending upon various factors such as the characteristics of the constituent being targeted for concentration estimation, the general type of biological cell for which constituent concentrations are being estimated, the solution or fluid suspending the biological cell, the characteristics of camera 28 and/or the rate of rotation of cell 44 or the frequency at which 2D images are captured. In some implementations, memory 36 or another database may contain multiple lookup tables or multiple formulas, wherein a particular lookup table or particular formula may be chosen by processor 32 based upon operator input or automatic determinations by processor 32 regarding such factors.

In some implementations, rather than determining a 3D light intensity value from multiple 2D light intensity values before determining a 3D CCC estimate from the 3D light intensity value, processor 32 may use a lookup table, a set of lookup tables, a formula or a set of formulas to determine a 3D CCC estimate for an individual voxel directly from the multiple 2D light intensity values. In some implementations, processor 32 may determine a 2D CCC estimate for a particular voxel for each of the 2D images, wherein a lookup table, set of lookup tables, formula or set of formulas are used to determine a 3D CCC estimate for the individual voxel from the multiple 2D CCC estimates. A 2D CCC estimate is a CCC estimate based upon a 2D light intensity value of a region of a 2D image. As should be appreciated, the time at which a light intensity value (2D or 3D) may be converted to a CCC value (2D or 3D) prior to determining the final 3D CCC estimate for an individual voxel may vary.

In some implementations, instructions 154 direct processor 32 to utilize the light intensity values to determine 2D CCC estimates for the stacks 272, wherein the total concentration or amount of a particular constituent within each stack 272 is estimated. The 3D CCC values for each of the individual voxels may then be determined for each individual voxel of matrix 260 may then be determined from a combination of the 2D CCC estimates for the stacks. For example, a 3D CCC value for an individual voxel may be determined using the 2D CCC estimates for the stacks that intersect one another at the individual voxel.

Although the determination of a CCC estimate for a particular individual voxel in FIG. 9 has been described as being based upon a combination of the individual light intensity values from three different regions of three different 2D images 268 at three different angular positions with respect to biological cell 44, it should be appreciated that the determination and assignment of such a CCC estimate for the particular individual voxel may be based upon a combination of light intensity values from corresponding regions of greater than three 2D images. For example, with respect to voxel 262-5, additional 2D images at different angular positions about biological cell 44 may have particular regions having light intensity characteristics that are also attributable to a stack of voxels containing voxel 262-5. To carry out block 212, processor 32 may additionally determine the CCC estimates for other voxels 260 based upon such additional regions from such additional 2D images. Determining a CCC estimate for an individual voxel using a greater number of 2D images at a greater number of different angular positions may enhance the accuracy of the CCC estimate for the particular voxel.

Model formation instructions 158 of memory 136 (shown in FIG. 2) direct processor 32 to carry out block 212 of method 200 shown in FIG. 3. Instructions 158 direct processor 32 to generate a three-dimensional model of biological cell 44, wherein the model identifies the different concentrations for a particular constituent or type of molecule in different voxels or regions of the biological cell 44. The model may have corresponding boxes that correspond to the voxel used to partition biological cell 44. Each of the voxels of the model may be provided with visible markings, color or other graphics based upon the CCC estimate assigned to the particular voxel. As a result, the model may serve to identify where different concentrations of a particular targeted constituent or molecule are located within biological cell 44.

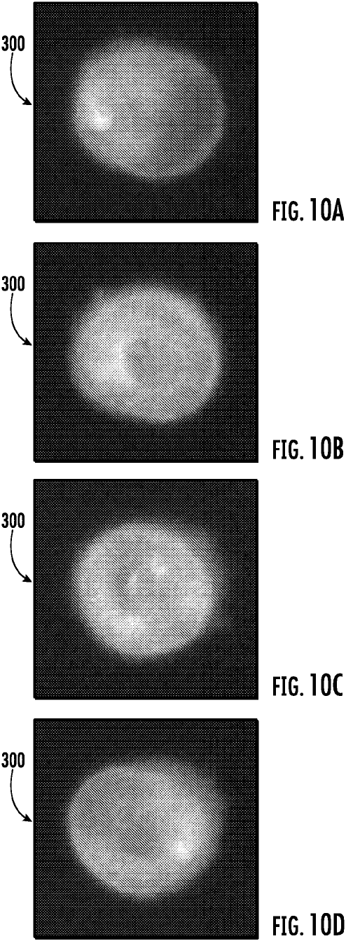

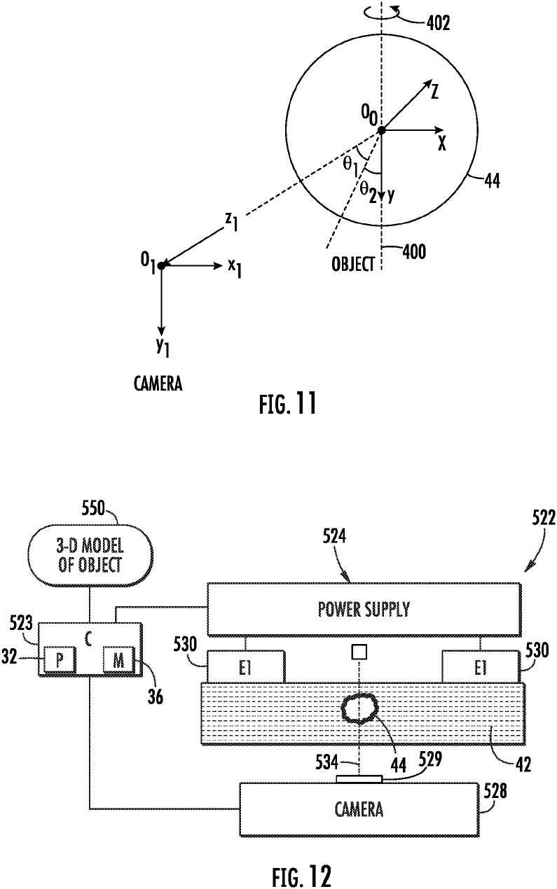

FIGS. 10A, 10B, 10C and 10D are illustrate different views, taking from different angular perspectives, of an example model 300 generated for the example biological cell 44. In the example illustrated, the brighter portions of model 300 correspond to those regions or voxels of the biological cell 44 having a higher concentration of the target molecule or constituent. In other implementations, such as where concentration of a target constituent or molecule is based upon the darkness or presence of a shadow, darker portions of model 300 may correspond to those regions or voxels of the biological cell having a higher concentration of the target molecule or constituent.

In some implementations, instructions 158 may direct processor 32 to generate a model based upon the determined concentrations for multiple different targeted constituents of a biological cell. For example, the above process may be repeated for multiple different types of molecules or different types of constituents of a biological cell or of multiple biological cells. The example model may have a first type of graphic or color of graphic representing a first target molecule or target constituent, identifying those regions of the biological cell where higher concentrations of the first target molecule or target constituent exist. The example model may have a second type of graphic or color of graphic, different than the first type of graphic or first color graphic, representing a second target molecule or target constituent, further identifying those regions of the biological cell where higher concentrations of the second target molecule or target constituent exist.

### Example Cell Voxel Stack to 2D Image Region Correspondence

The following describes an example of how processor 32 may partition a biological cell, such as biological cell 44, and determine what stacks of voxels of the biological cell contribute to or correspond to individual regions of a 2D image of the biological cell. As should be appreciated, the mathematical equations provided below may form or be used to form portions of instructions 150 and 154 (described above with respect to FIG. 2) for processor 32. As shown by FIG. 11, camera 28 may have a camera coordinate system 01-X₁Y₁Z₁ whereas the biological cell 44 has a coordinate system 0-XYZ. Transformation between the two coordinate systems can be established by 3D translation vector 001, the direction of the rotating axis 400 as indicated by arrow 402 and the rotating angle ⊖ along the rotating axis from 2D image to 2D image (frame to frame).

In the example being illustrated, it is assumed that the rotational axis is not changed and at the speed of rotation is constant. A geometry model the system is defined with three major components: a world coordinate system x_{w}, y_{w}, z_{w}, which is static to the cell 44, the cameras coordinate system x_{c}, y_{c},z_{c}, and the transformation between them (rotation R and translation t̅). FIG. 5 illustrates the camera-cell relative movement under the world coordinate system, viewed from the direction of the cell spinning axis. Given the homogenous representation of a point in the world coordinate system, p̅_{w}, equals (x_{w}, y_{w},z_{w}, 1)^{T}, its projection in the camera image p̅_{c} equals (x_{c,} y_{c}, z_{c,} 1)^{T} and may be expressed as follows:

$${\vec{p}}_{c} = K \left[R \left|\vec{t}\right)\right] {\vec{p}}_{w} ,$$

where K is a cameras intrinsic matrix, while R and t are the rotation matrix and translation vector from the camera to the world.

The camera’s intrinsic matrix

$$\text{K} \text{=} \left[\begin{matrix}{f}_{x} & s & {x}_{0} \\ 0 & {f}_{y} & {y}_{0} \\ 0 & 0 & 1\end{matrix}\right]$$

may be defined by several intrinsic parameters, the focal lengths fₓ and f_{y} in the X and Y axes, respectively. The axis skew s may describe the sheer distortion and principal point offset (x₀, y₀). The value K be obtained through camera calibration with the pin hole camera model. In the example illustrated it is assumed that the axis skew s is zero and the principal point offset is in the center of the image. The full length be defined as a distant tree in the pinhole in the image plane. Define the distance between the panel and the center of the biological cell 44 as d, the overall magnification of the microscope or camera m in the cameras pixel size as pₓ and p_{y} in the X and Y axes, then from the similar triangles that are formed:

$$\frac{{f}_{x}}{d} = \frac{m}{{p}_{x}} , \frac{{f}_{y}}{d} = \frac{m}{{p}_{y}}$$

The values for m, pₓ and p_{y} may found from the camera/microscope’s specifications. The value for d maybe estimated from the working distance of the objective lens of the camera/microscopes working distance.

The origin of the world coordinate system X_{w}Y_{w}Z_{w} is defined to be at the cell’s centroid, and its x-y plane to be parallel to the image plane of the first captured image I₁. Using the world coordinate system as the reference, the camera is moving around the cell on a circular orbit at a constant speed. Under the assumption of steady rotation, the orbit can be viewed as a circle centered at the cell’s centroid (origin of the world coordinate system), and the N imaging points on this circle are evenly distributed, defined by the camera’s frame rate. Accordingly, in our geometry model, the rotation angle between the two coordinate systems changes by 360/N degrees between frames. For the iₜₕ image, the rotation angle is;

$${θ}_{i} = \frac{360 \left(i - 1\right)}{N} , i = 1 , … , N$$

Processor 32 defined the origin of the world coordinate system X_{w}Y_{w}Z_{w} to be at the cell’s centroid, and its x-y plane to be parallel to the image plane of the first captured image I₁. Using the world coordinate system as the reference, the camera is moving around the cell on a circular orbit at a constant speed. Under the assumption of steady rotation, the orbit can be viewed as a circle centered at the cell’s centroid (origin of the world coordinate system), and the N imaging points on this circle are evenly distributed, defined by the camera’s frame rate. Accordingly, in our geometry model, the rotation angle between the two coordinate systems changes by 360/N degrees between frames. For the iₜₕ image, the rotation angle is

$${θ}_{i} = \frac{360 \left(i - 1\right)}{N} , i = 1 , … , N .$$

When the target cell is centered in the camera’s field of view, the cell’s position in the camera’s coordinates and the image plane are illustrated in FIG. 2. In this case, the translation between the world and camera coordinate system is constant and equals to the distance between the pinhole and the object center. As a result:

$${\vec{t}}_{i} = \vec{t} = {\left(0 , 0 , d\right)}^{T} , i = 1 , … , N$$

### Example Estimation of CCCs for Individual Cell Voxels From 2D Images

The following describes an example of how processor 32 may allocate the light intensity values for individual regions of the 2D image to individual voxels of the stack or stacks of voxels identified as corresponding to the regions as described above. The following further describes an example of how processor 32 may determine a 3D light intensity values for individual voxels based upon a combination of multiple different 2D light intensity values from different 2D images. As described above, this 3D light intensity value may be then used to determine or estimate a CCC value for an individual voxel. The CCC values for the individual voxels may then be utilized to model the biological cell 44.

As shown above in FIG. 6, processor 32 defines a region of interest (ROI) to in 3D space, wherein the cube contains the biological cell 44. It is this cube that is partitioned into voxels which enclose and contain the biological cell 44. The individual voxels are apportioned light intensity values which correspond to constituent concentrations based upon a measured point spread function (PSF). This point spread function differently weights the allocation of the total light intensity value detected at a region of the 2D image to the different voxels based upon the relative positioning of the different voxels in the matrix of voxels or stack of voxels.

When modeling the 3D to 2D transformation in a microscopy system, processor 32 treats the system’s PSF as a 3D convolution kernel PSF(x_{w}, y_{w}, z_{w}) on top of the projection model illustrated in Eq0.1 above. Given a point p̅_{w1} = (x_{w1}, y_{w1}, z_{w1}, 1)^{T} with intensity value I_{w1} in 3D, it’s projection p̅_{c1} = (x_{c1}, y_{c1}, 1)^{T} in a 2D image can be obtained using Eq. 1. Then the signal at p̅_{c1} will spread in its 2D local neighborhood, the size of which is determined by the PSF function, and how far away p̅_{w} is from the center of the cell, i.e. the z coordinate of p̅_{w1.} The intensity matrix I_{c1} in the local neighborhood centered at p̅_{c1} is

$${I}_{c 1} = {I}_{w 1} ∗ P S F \left({x}_{w} , {y}_{w} , {z}_{w 1}\right)$$

In addition, there will be points in 3D that project to the neighbor pixels of p̅_{c1}. And the intensity value of those points will add to the image intensity at p̅_{c1} if it’s within the range of PSF. the image value at pixel (x_{c1}, y_{c1}) is a weighted sum of many voxels in 3D. As a result, processor 32 may model the light intensity transformation from 3D to 2D as a linear system with random noise, represented by.

$$I \left(x , y\right) = {\sum }_{v ∈ R O I} P S F ∗ \left(K \left[R \left|\vec{t}\right)\right] {\vec{p}}_{v}\right) + r n \left(x , y\right)$$

where ν represents all voxels in the Region of Interest (ROI); p̅_{ν} is the homogenous coordinate of the center of ν; K, R, and t̅ are the camera’s intrinsic matrix, the rotation matrix and translation vector from the camera to the world; PSF is the point spread function, a fixed 3D kernel that can be measured given the settings of the microscopy system; * denotes the convolution operation; rn (x,y) represents random noise. The output I(x, y) is the observed image at the viewing point specified by R, and t̅.

As described above, voxels (cubes) are used as the basic building blocks to define the density distribution within cellular structures. Processor 32 defines a cubical Region of Interest (ROI) in a 3D space that is large enough to enclose the target cell 44. The ROI’s size may be chosen based on the camera’s resolution, the magnification of the microscopic imaging system and the size of the cell. One way is to capture a scale target, such as a stage micrometer, as part of the calibration process. The location of the ROI was determined based on the location of the cell in the captured image. One way to simplify the calculation is to place the target cell in the center of the image. Then the center of the ROI is located at (0,0,d)^T with respect to the camera’s coordinate system.

Processor 32 may initialize the ROI to with a uniform voxel grid, for example 40-by-40-by-40 voxel grid. The computational load grows exponentially as the slice number increases in each dimension. Choosing the right voxel size is a tradeoff between the target resolution and the computational resources that are available. Processor 32 may utilize a grid of N-by-N-by-N voxels, and M images of height h, width w are taken during one rotation cycle. As a result, an optimization problem arises with N^3 variables, and w*h*M observations, i.e. constraints. According to the above equations, each region light intensity (observation) is the linear combination of a subset of variables. This problem can be formulated by a matrix multiplication.

$$A \vec{X} = \vec{B}$$

where B̅ is the observation vector formed by all the pixels in the captured images; X̅ is the vector of unknown variables, in this case, voxel densities; A is a matrix of w*h*M rows and N^3 columns, where each row is the weights that used to transform the volume density into its corresponding observation points. The matrix A can be obtained using Eq. 2 above. The center of each voxel was used to represent the voxel’s coordinate in 3D. A is likely to have hundreds of thousands of rows and columns. Also, A is a sparse matrix, since each observation only depends on a small portion of the volume.

This linear system could be over-determined or under-determined, thus likely does not have a single solution. Processor 32 may use the least square solution X̅ as an approximation of the true solution such that

$$\hat{\vec{X}} = a r g m i {n}_{\vec{X}} {\left‖\vec{B} - A \vec{X}\right‖}_{2}^{2} + \text{regularization}$$

for all X̅ in the solution space, given that each element in X̅ should be within the same range, for example [0, 255].

The regularization term in the equation above is an analytical term to account for any constrains to apply when finding the solution. It could be based upon, but not limited to, prior knowledge regarding the surface of cell, or the rough locations of the CCC to be estimated.

FIG. 11 is a diagram schematically illustrating an example 3D biological CCC reconstruction or modeling system 520. FIG. 7 illustrates a specific example of a microfluidic chip that may be used to image and model cell constituent concentrations using 2D images. System 520 comprises a microfluidic chip 522 and a controller 523. Microfluidic chip 522 comprises a microfluidic passage 540 for containing and suspending an example biological cell 44 in a liquid 42. Microfluidic chip 522 further comprises a cell rotator 524 and camera 528. Cell rotator 524 comprises electrodes 530 and power supply 532. Controller 523 control power supply 532 such that electrodes 530 apply dielectrophoretic to suspend and rotate the biological cell 44. In some implementations, cell rotator 524 utilizes charged electrodes 530 to establish a the nonrotating nonuniform electric field for rotating biological cell 44. In some implementations, the nonrotating nonuniform electric field is an alternating current electric field having a frequency of at least 650 kHz and no greater than 300 kHz. In one implementation, the nonrotating nonuniform electric field has a voltage of at least 0.1 V rms and no greater than 100 V rms.

Camera 528 functions to serve as a microscope while also capturing three-dimensional images of the rotating biological cell 44. Camera 528 may be similar to camera 28 described above. In some implementations, camera 528 comprises a wide-field non-confocal camera or microscope. Camera 528 comprises optics 529 for magnifying biological cell 44. In some implementations, optics 529 may be separate from camera 528, being disposed between camera 528 and the biological cell 44 being imaged. Camera 528 transmits the captured 2D images of the rotating biological cell, at different angles about the rotational axis 534 controller 523. In some implementations, microfluidic chip 52 may additionally comprise a light source 538 which directs light through biological cell 44 to the sensing element of camera 528, wherein the differing light intensity regions of the two-dimensional images correspond to shadows produced by the reflectivity or light absorption of the target cell constituents being analyzed.

Controller 523 utilizes the 2D images captured by camera 528 two model biological cell 44, wherein the model depicts different CCC estimates for different regions of the biological cell 44. Controller 523 comprises processor 32 and memory 36 as described above. Controller 523 outputs a 3D model 550 of the biological cell 44.

### EXAMPLE

In an example application, breast cancer cells expressing cytoplasmic GFP (MDA-MB-231-GFP from Gen-Target, SCO40-PURO) were cultured in standard DMEM cell media with 10% FBS and 10% pen-strep-glut. For all rotation experiments, cells were suspended in specialized buffer to protect cells from electrical fields during spinning. Buffer ingredients include sucrose, dextrose, BSA, catalase, magnesium acetate, calcium acetate, pluronic and PBS.

The cells are a transgenic line expressing GFP cytoplasmically, exhibiting fluorescence throughout the cell except the nucleus. This facilitated visualization of the shape and morphology of the cell as a whole. To visualize nuclei, the cells were stained with Hoechst 33342.

The cells were placed on the chip for spinning and subjected to an electric field with a range of 3-7V and 80-500 kHz depending on cell type. The 2D images were captured with an inverted Nikon Eclipse Ti and Canon 5D MarklV using a 40X objective with N.A. 0.6 and 3.7-2.7 mm working distance. The objective observed the cells spinning on the electrode edge through a 1 mm glass substrate which supported the electrodes. Video recordings were obtained at 30 frames per second.

Although the present disclosure has been described with reference to example implementations, workers skilled in the art will recognize that changes may be made in form and detail without departing from the disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

1. A three-dimensional (3D) biological cell constituent concentration reconstruction method comprising:
capturing two-dimensional images of a biological cell at different angles;
virtually partitioning the biological cell into 3D stacks of voxels;
assigning cell constituent concentration estimations to respective voxels, each cell constituent concentration estimation being based upon a plurality of the two-dimensional images; and
forming a 3D cell constituent concentration model of the biological cell based upon the voxels and respective cell constituent concentration estimations.

2. The 3D biological cell constituent concentration reconstruction method of claim 1, wherein a wide-field non-confocal camera is used to capture the two-dimensional images of the biological cell at different angles.

3. The 3D biological cell constituent concentration reconstruction method of claim 2 further comprising rotating the biological cell between the different angles.

4. The 3D biological cell constituent concentration reconstruction method of claim 1, wherein the determining of the cell constituent concentration estimations for the respective voxels comprises:
obtaining a light intensity measurement for a region of one of the two-dimensional images, the region corresponding to a portion of the three-dimensional stacks of the voxels; and
allocating a portion of the light intensity measurement to each of the voxels of the portion of the 3D stacks of voxels, wherein the cell constituent concentration estimation for each of the voxels of the portions of the 3D stacks of voxels is based upon the light intensity allocated to each of the voxels of the 3D stacks of voxels.

5. The 3D biological cell constituent concentration reconstruction method of claim 4, wherein allocation of the light intensity to the voxels of the portion of the 3D stacks of voxels is weighted based upon relative positions of the voxels in the 3D stacks of voxels.

6. The 3D biological cell constituent concentration reconstruction method of claim 4 further comprising staining the biological cell with a fluorescent agent.

7. The 3D biological cell constituent concentration reconstruction method of claim 1, wherein the forming of the 3D cell constituent concentration model of the biological cell based upon the voxels and respective cell constituent concentration estimations is by defining an inverse problem analytically and searching for a solution to the inverse problem.

8. The 3D biological cell constituent concentration reconstruction method of claim 7, wherein the inverse problem is linear.

9. A three-dimensional (3D) biological cell constituent concentration reconstruction system comprising:
a cell rotator to rotate a biological cell;
a camera to capture two-dimensional images of the biological cell at different angles;
a processor; and
a non-transitory computer-readable medium containing instructions to direct the processor to:
virtually partition the biological cell into 3D stacks of voxels;
assign cell constituent concentration estimations to respective voxels, each cell constituent concentration estimation being based upon a plurality of the two-dimensional images; and
form a 3D cell constituent concentration model of the biological cell based upon the voxels and respective cell constituent concentration estimations.

10. The system of claim 9, wherein the camera comprises a wide-field non-confocal camera.

11. The system of claim 9, wherein the instructions direct the processor to determine the cell constituent concentration estimations for the respective voxels by:
obtaining a light intensity measurement for a region of one of the two-dimensional images, the region corresponding to a portion of the three-dimensional stacks of the voxels; and
allocating a portion of the light intensity measurement to each of the voxels of the portion of 3D stacks of voxels, wherein the cell constituent concentration estimation for each of the voxels of the portion of 3D stacks of voxels is based upon the light intensity allocated to each of the voxels of the portion of 3D stacks of voxels.

12. The system of claim 11, wherein allocation of the light intensity to the voxels of the portion of 3D stacks of voxels is weighted based upon relative positions of the voxels in the 3D stacks of voxels.

13. A non-transitory computer-readable medium containing instructions to direct a processor, the instructions comprising:
partition instructions to direct the processor to virtually partition a biological cell into 3D stacks of voxels;
cell constituent concentration estimation instructions to direct the processor to determine cell constituent concentration estimations for respective voxels, each cell constituent concentration estimation being based upon a plurality of two-dimensional images of the biological cell; and
model formation instructions to direct the processor to form a 3D cell constituent concentration model of the biological cell based upon the voxels and respective cell constituent concentration estimations.

14. The medium of claim 13, wherein the cell constituent concentration estimation instructions direct the processor to determine the cell constituent concentration estimations for the respective voxels by:
obtaining a light intensity measurement for a region of one of the two-dimensional images, the region corresponding to a portion of the three-dimensional stacks of the voxels; and
allocating a portion of the light intensity measurement to each of the voxels of the portion of 3D stacks of voxels, wherein the cell constituent concentration estimation for each of the voxels of the portion of 3D stacks of voxels is based upon the light intensity allocated to each of the voxels of the portion of 3D stacks of voxels.

15. The medium of claim 14, wherein allocation of the light intensity to the voxels of the portion of 3D stacks of voxels is weighted based upon relative positions of the voxels in the portion of 3D stacks of voxels.
